(19) United States
(12) Patent Application Publication
(10) Pub. No.: US 2026/0317228 A1
(43) Pub. Date: Oct. 15, 2026

(54) GLASS SHEET WITH AN ENAMELED ZONE

(71) Applicant: SAINT-GOBAIN SEKURIT FRANCE, THOUROTTE (FR)

(72) Inventors: Pauline GLATZ, COURBEVOIE (FR); Pauline GIRARD, COURBEVOIE (FR)

(21) Appl. No.: 19/120,067

(22) PCT Filed: Oct. 9, 2023
(86) PCT No.: PCT/EP2023/077846

§ 371 Date: Apr. 10, 2025

(30) Foreign Application Priority Data
Oct. 11, 2022 (FR) FR2210399

(51) Int. Cl. C03C 17/34

(52) U.S. Cl. CPC C03C 17/3417; C03C 2217/21; C03C 2218/113; C03C 2218/17

(57) ABSTRACT

A material includes a glass sheet one face of which includes an enameled zone, such that in the enameled zone the glass sheet is coated with an opaque mineral layer and, under at least part of said opaque mineral layer, with a transparent mineral coating which is not an enamel, the transparent mineral coating including, in the enameled zone, a first zone wherein the transparent mineral coating has a first thickness and a second zone wherein the transparent mineral coating has a second thickness, the first and second thicknesses being different.

The invention relates to the field of glazing, in particular glazing for buildings or transport vehicles.

Glass sheets are known to be coated on all or part of their surface with opaque mineral layers, in particular opaque enamel layers. An enamel is a layer comprising a vitreous or vitrocrystalline binder and pigments, obtained by depositing a fluid enamel composition comprising a glass frit, pigments and an organic medium and then firing. Enamel coatings are often decorative, but can also provide masking and protective functions, e.g., against ultraviolet radiation.

The aim of the invention is to provide enameled glazings with a decorative appearance seen from the side opposite the side bearing the opaque layer, and which can be manufactured simply and economically.

For this purpose, the invention has as object a material comprising a glass sheet one face of which comprises an enameled zone, such that in said enameled zone the glass sheet is coated with an opaque mineral layer and, under at least part of said opaque mineral layer, with a transparent mineral coating which is not an enamel, said transparent inorganic coating comprising, in said enameled zone, a first zone wherein the transparent inorganic coating has a first thickness and a second zone wherein the transparent inorganic coating has a second thickness, said first and second thicknesses being different.

An object of invention is also a method for obtaining such a material, comprising the deposition, on one face of a glass sheet and in a so-called enameled zone, of a transparent mineral coating which is not an enamel, then, on this transparent mineral coating, of an opaque mineral layer, said transparent mineral coating comprising, in said enameled zone, a first zone wherein the transparent mineral coating has a first thickness and a second zone wherein the transparent mineral coating has a second thickness, said first and second thicknesses being different.

An object of the invention is also a glazing comprising a material according to the invention.

The inventors were able to demonstrate that the presence of a transparent mineral coating and the existence of a plurality of zones wherein the transparent mineral coating has a different thickness make it possible to form a decoration visible from the side opposite the glazed side. The reflective appearance of the enamel is modulated by the thickness of the underlying coating, and the contrast between the different zones creates a decorative effect. In addition, this decoration is obtained very simply, using a single opaque mineral layer (in particular enamel) and possibly after a single firing step.

The glass sheet is preferably made of soda-lime glass. It is advantageously obtained by the float method. Nonetheless, other glass compositions are possible, for example compositions of borosilicate or aluminosilicate type.

The glass sheet may be clear glass, or, preferably tinted glass, for example in green, gray, bronze or blue. In the case of tinted glass, the chemical composition of the glass sheet advantageously comprises iron oxide, in a content by weight ranging from 0.5 to 2.5%. It may also comprise other coloring agents, such as cobalt oxide, chromium oxide, nickel oxide, erbium oxide or else selenium. In the case of clear glass, the chemical composition of the glass sheet advantageously comprises iron oxide, in a content by weight ranging from 0.01 to 0.15%.

The glass sheet is preferably between 0.7 and 19 mm thick, particularly between 1 and 6 mm, or even between 2 and 4 mm. The glass sheet preferably has a surface area of at least 1 m².

The glass sheet may be flat or bent. It is generally flat during the transparent mineral coating and opaque mineral layer deposition stages. However, certain deposition techniques, notably digital printing, enable these coatings to be deposited on a curved sheet. In the case of glazing for vehicles, in particular motor vehicles, it is then preferably curved and thus has a curved shape in the final glazing.

The term “enameled zone” generally refers to the area covered by the opaque mineral layer, which is most often, but not necessarily, an enamel layer, as detailed below.

The enameled zone can cover all or part of the surface of the glass sheet, depending on the intended application. It can cover the entire surface of the glass sheet, for example in the case of spandrels. Alternatively, it can cover only part of the surface of the glass sheet, in particular from 2 to 80%, or even from 5 to 50% or from 10 to 25%. In the case of vehicles, especially motor vehicles, the enameled zone is preferably in the form of a peripheral strip. “Peripheral strip” is intended to mean a strip closed on itself which, from each point of the periphery of the glass sheet, extends toward the interior of the glass sheet over a certain width, typically of between 1 and 20 cm. This perimeter strip is designed to conceal and protect from ultraviolet radiation the polymeric gaskets used to fasten and position the glazing in the bodywork bays, as well as various mechanical or electrical components (heating circuits, rear-view mirror bases, sensors or cameras, etc.).

In one embodiment, the transparent mineral coating is in contact with the glass sheet. In this case, the glass sheet is preferably coated only with the coating and the opaque mineral layer in the enameled zone.

Alternatively, other layers or stacks of layers can be interposed between the glass sheet and the transparent mineral coating. For example, it may involve thin layers or stacks of thin layers comprising at least one functional layer, for example an electroconductive or low-emissivity layer, particularly silver-based or Transparent Conductive Oxide (TCO) based such as indium and tin oxide or doped tin or zinc oxides. In particular, such layers or stacks can perform heating (defrosting, demisting) and/or solar control and/or thermal insulation functions.

The opaque mineral layer is preferably in contact with the transparent mineral coating.

The transparent mineral coating is present under at least part of the opaque mineral layer. It may be present under the entire opaque mineral layer, that is, in the entire enameled area. Alternatively, it can be present under only part of the opaque mineral layer, for example under 2 to 80%, particularly 10 to 60%, of the opaque mineral layer. This is the case, for example, when the purpose of the transparent mineral coating is to form a decoration in only part of the enameled zone.

In both cases described above, the transparent mineral coating can also be present on all or part of the non-enameled area, where this exists. It can then be present on the entire sheet of glass. This is the case, for example, when the transparent mineral coating has another function that is also useful in the clear view of the glazing, such as an optical function, particularly anti-reflective. Alternatively, the transparent mineral coating may not be present in the non-enameled area.

The presence of a transparent mineral coating modifies the appearance of the enamel as seen in reflection through the glass sheet. It became apparent that this aspect differed according to the thickness of the coating. The existence of a plurality of zones where the coating has different thicknesses thus makes it possible to obtain a different appearance in each zone, giving the possibility of obtaining a decoration.

The decoration can be of any kind: various patterns, e.g., geometric, logos, etc. By way of example, the decoration can create a transition zone between the bodywork of a vehicle and the clear view of the glazing.

To achieve an attractive appearance, the transparent mineral coating preferably has high light transmittance. The transparent mineral coating is preferably such that, when deposited on a sheet of clear glass, the light transmittance is at least 70%, in particular at least 80%, or even at least 88%. Clear glass is a glass whose chemical composition includes iron oxide as the sole colorant, in a proportion by weight of between 0.05 and 0.12%. An example of clear glass is Planiclear® glass marketed by the applicant.

The transparent mineral coating is preferably colorless (that is, non-tinted). In particular, the colorimetric coordinates a* and b* (illuminant D65, CIE-1964 observer) in transmission of the transparent mineral coating seen through a sheet of clear glass are preferably between 0 and 5, in particular between 0 and 2, or even between 0 and 1.

In one embodiment, the transparent mineral coating comprises a single layer. The existence of zones of different thicknesses is then obtained by locally varying the thickness of the single layer during deposition.

In another embodiment, the transparent mineral coating comprises, at least in the first or second zone, a plurality of superimposed layers, in particular two, three or four layers. In this case, the thickness of the coating in a zone corresponds approximately to the sum of the thicknesses of each of the layers forming the coating in that zone. The thickness of the coating may not correspond exactly to the sum of each of the thicknesses of the individual layers when the deposition of one layer results in a slight reduction in the thickness of the layer below. These layers are generally of the same chemical nature, but may alternatively be of different chemical natures. Zones of different thicknesses are then obtained by depositing a different number of layers in each zone. In this way, the number of layers forming the coating in a first zone is different from the number of layers forming the coating in a second zone. By way of example, the coating can be formed by a single layer in a first zone and two layers in a second zone, the thickness of the coating in the second zone then being different from that of the coating in the first zone, typically double if the layers have the same thickness.

Irrespective of the embodiment, the number of zones corresponding to different thicknesses is not limited to two. The transparent mineral coating can therefore have, in addition to a first and second zone, a third zone wherein the coating has a third thickness, different from the first and second thicknesses. Generally speaking, the transparent mineral coating may comprise N zones Zₓ (N being at least 2 and x ranging from 1 to N), the thickness eₓ of the transparent mineral coating in zone Zₓ being different from the thickness e_{y} of the transparent mineral coating in zone Z_{y}, for any x different from y. For the sake of simplicity, N is preferably at most 10, better still at most 8 and even at most 5.

The term “zone” refers to areas located in the plane of the coating.

The reflective appearance of the opaque layer as seen through the glass sheet can be varied according to the thickness of the transparent mineral coating and its refractive index.

The thickness of the mineral coating in each zone (first, second, even third or more) is preferably between 30 and 1000 nm, particularly between 50 and 500 nm, or even between 60 and 300 nm.

Preferably, the ratio between the second thickness and the first thickness is at least 1.2, in particular at least 1.5, or even at least 1.8. It is usually no more than 4, or even no more than 3. Generally speaking, when the transparent mineral coating comprises N zones Zₓ, the ratio between the thickness in zone Zₓ and the thickness in zone Zₓ₋₁ is preferably at least 1.2, in particular at least 1.5, or even at least 1.8, and often at most 4 or at most 3.

The refractive index of the transparent mineral coating (typically for a wavelength of 550 nm) is preferably between 1.3 and 2.4, particularly between 1.4 and 2.0. The refractive index, as well as the thickness of the transparent mineral coating, can influence the perceived color. If the transparent mineral coating is formed from a plurality of layers of different chemical natures, the refractive index of the coating corresponds to the average of the refractive indices of each of the layers, weighted by the thickness of each of the layers.

The transparent mineral coating is preferably based on an oxide, nitride or oxynitride of one or more elements selected from Si, Zr, Ti, Zn, Sn and Al. It is preferably based on an oxide of one or more elements selected from Si, Zr, Ti, Zn, Sn and Al. Preferred oxides are silicon, zirconium and titanium oxides. Preferably, the transparent mineral coating is based on silicon oxide, in particular it consists of silicon oxide. The choice of element allows the refractive index of the coating to be adjusted. Silicon oxide (also known as silica) has a refractive index of around 1.4.

The transparent mineral coating is preferably a sol-gel coating. In this case, the coating is deposited using a sol-gel method. The sol-gel coating is preferably based on or consists of silicon oxide. The expression “based on” is understood to mean that the coating comprises at least 50% by weight of silicon oxide. It can contain other oxides, such as titanium or zirconium, to vary the refractive index of the coating.

A sol-gel method is a method wherein a sol containing precursors of the coating to be produced is deposited on the glass sheet by various means, such as spraying, curtain, laminar flow coating, roller, screen printing, inkjet deposition, etc. Screen-printing or inkjet deposition is preferred here, as it makes it easy to deposit the coating only in the desired areas.

The sol preferably contains organometallic precursors of the coating to be produced, for example tetraethyl orthosilicate (TEOS). The coating is then generally dried before the enamel layer is deposited, and annealed to densify it. The annealing preferably takes place during the same step as the firing of the enamel, generally during the bending and or tempering of the glass sheet.

Alternatively, the coating can be deposited by PVD or CVD (chemical vapor deposition) methods, such as sputtering, or by plasma-enhanced chemical vapor deposition (PECVD), possibly under atmospheric pressure (APPECVD). Masks can then be used to apply the coating only in the desired areas. However, these methods are more complex than silkscreen or inkjet.

If the transparent mineral coating comprises a plurality of superimposed layers, at least in the first or second zone, coating deposition comprises successive steps for depositing each of the layers. For example, successive screen printing passes can be carried out using different screen printing screens. A drying step is preferably carried out between two successive layer deposition steps, typically at a temperature of between 12° and 200° C.

When the transparent mineral coating comprises a single layer, coating deposition comprises just one deposition step. In the case of screen-printing deposition, zones of different thicknesses can be obtained in one step by various means, in particular as described in application W2018/229449.

Generally speaking, the opaque mineral layer is a layer comprising pigments in a mineral binder. The opaque mineral layer is preferably an enamel or a silicate paint.

The coating is opaque, which means that the light transmittance factor in the enameled zone is less than 0.1%, in particular zero.

At least one, in particular each, pigment is preferably based on an oxide or a sulfide of iron, chromium, copper, cobalt, titanium and/or manganese. The color of the pigments, and therefore of the opaque mineral layer, is not limited: white, black, blue, red, yellow, green, etc. In the case of vehicle glazing, especially automotive glazing, the pigments are preferably black. The opaque mineral layer is then black, and advantageously has a colorimetric coordinate L* in reflection on the enameled side of less than 5, particularly 3. This measurement excludes specular reflection.

“Silicate paint” means a layer obtained from an aqueous paint composition comprising pigments and an aqueous solution of alkali metal silicate. The coating thus comprises pigments bound together by a silicate binder.

The aqueous solution of alkali metal silicate preferably comprises at least one sodium, potassium and/or lithium silicate. The aqueous solution of alkaline silicate may consist of a mixture of aqueous solutions of different alkaline silicates, for example a mixture of at least one aqueous solution of sodium and at least one aqueous solution of potassium.

The paint composition preferably comprises at least one mineral filler, in particular chosen from colloidal silica, feldspars, alumina and lamellar fillers. The lamellar fillers are preferably chosen from among talc, mica and clays, in particular clays based on silicate or aluminosilicate such as kaolinite, illite, montmorillonite and sepiolite. The paint composition advantageously comprises a mixture of several mineral fillers.

The mineral fillers and the pigments preferably have a particle size distribution (by volume) such that the d90 thereof is less than 10 μm.

The paint composition may also comprise a base, in particular an alkaline hydroxide.

The paint composition may additionally contain various additives, such as at least one dispersant, at least one anti-foaming agent, at least one thickening agent, at least one stabilizing agent and/or at least one hardening agent.

In the layer of mineral paint, the weight content of alkaline silicate is preferably comprised between 7% and 60%, in particular between 15 and 55%. The total weight content of pigments and mineral fillers is preferably comprised between 20 and 90%, in particular between 30 and 70%. The total content of additives is preferably comprised between 0.1 and 5%. These contents apply also for the aqueous paint composition (in that case it is a percentage relative to the dry extract).

The term enamel layer refers to the layer both before firing and after firing.

Before firing, the enamel layer comprises a glass frit, pigments and an organic medium. After firing, the enamel layer comprises pigments and a vitreous or vitrocrystalline matrix obtained by melting the glass frit. The glass frit and/or the vitreous matrix preferably consists of a bismuth and/or zinc borosilicate.

The enamel layer is preferably obtained by screen printing a fluid enamel composition comprising a glass frit, pigments and an organic medium. To this end, the enamel composition is deposited, in particular using a doctor blade, onto the glass sheet through apertures of a screen. The apertures of the screen are blocked off in the part corresponding to the regions of the glass sheet that are not to be covered, so that the enamel composition can pass through the screen only in the regions to be printed, according to a pre-defined pattern. Other deposition techniques such as digital printing techniques (inkjet, for example) are also possible.

In general, the opaque mineral layer, and therefore also the silicate paint layer, is advantageously deposited by these different techniques, in particular by screen printing or digital printing, especially inkjet.

Before firing, the opaque mineral layer, particularly the enamel layer, has a thickness preferably of between 10 and 30 μm, in particular between 15 and 25 μm. After firing, the thickness of the opaque mineral layer, particularly the enamel layer, is preferably between 5 and 15 μm, especially between 7 and 13 μm.

The method according to the invention preferably comprises a step of firing the opaque mineral layer, in particular the enamel layer, generally during tempering and/or bending of the glass sheet. If necessary, this step also serves to densify the sol-gel underlay. This step involves temperatures preferably ranging from 550 to 720° C. The invention thus makes it possible to create a decoration with a single firing step.

In the case of a silicate paint, the coated glass sheet may undergo a pre-firing step, designed to harden the paint layer before a possible tempering and/or bending step. Alkali silicate-based mineral paints can usually be cured at moderate temperatures, in the range 200-250° C.

The curving can in particular be created using gravity (the glass deforms under its own weight) or through pressing, at temperatures typically ranging from 550 to 650° C. In the case of laminated glazing, the two glass sheets can be curved together (which is the preferred mode) or separately. Prior to the bending step, the method may also include a pre-firing step for the first glass sheet coated with the opaque layer, preferably at a temperature of between 45° and 600° C. Such a pre-firing removes the organic medium, or in general any organic components that may be present in the opaque layer, and improves the latter's non-stick properties. It is important to avoid any sticking between the opaque layer and the other sheet of glass, or between the opaque layer and the bending tools.

The glazing according to the invention may comprise a single sheet of glass. In this case, the glass sheet is preferably thermally tempered. It can be either hardened or annealed.

Alternatively, the glazing can be a laminated glazing, wherein the glass sheet of material according to the invention is adhesively bonded to another glass sheet by means of a laminating interlayer, for example of polyvinyl butyral. In this case, the glass sheets are not thermally tempered.

In the case of laminated glazing, the opaque mineral layer, in particular the enamel layer, is preferably arranged on face 2 or face 4, that is, respectively the face opposite the face (referred to as 1) facing the outside (of the vehicle or building) or the innermost face. In this case, the decor is visible from the outside.

The glazing can also be a multiple glazing, for example double or triple, wherein the glass sheet of material according to the invention is bonded to at least one other glass sheet by means of a peripheral spacer frame, typically made of metal or polymeric material.

The glazing according to the invention can be a vehicle glazing (land, air or sea), in particular a motor vehicle glazing, such as a rear window, windscreen, side window, roof, headliner or quarter window.

The glazing can alternatively be a building glazing, e.g., used in a façade or window, or a furniture or decorative glazing (partitions, doors, tables, etc.).

The following examples nonlimitingly illustrate the invention.

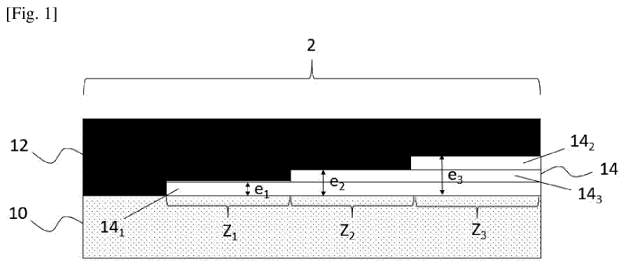

FIG. 1 illustrates an embodiment of the invention used in the example. More specifically, it illustrates a schematic cross-sectional view of a material according to the example. Of course, the thicknesses of the various elements are not shown to scale.

A sol-gel silica coating 14 has been deposited on part of a sheet of clear float glass (sold under the Planiclear® reference by the Applicant). This transparent mineral coating 14 was deposited by screen printing and comprised three zones Z₁ to Z₃.

In a first zone Z₁, coating 14 consisted of a single layer of silica 141. In a second zone Z₂, coating 14 consisted of two superimposed silica layers (141 and 142). In a third zone Z₃, the coating consisted of three superimposed silica layers (141, 142 and 143). In the example, the thicknesses (e₁, e₂ and e₃) of each of the silica layers were substantially identical. Coating 14 was deposited in three successive screen-printing steps, with a drying step at 160° C. for 180 seconds after each screen-printing step. Each layer had a wet thickness of around 10 μm.

On the coating 14, as well as on the part of the glass sheet 10 not coated by the coating 14, a layer of black enamel 12 has been deposited. The deposit was also screen-printed, and the wet enamel thickness was approximately 25 μm.

After drying (160° C., 180 seconds), the glass sheet was tempered by heating it to 690° C. and then rapidly cooling it using air nozzles.

After tempering, the visual appearance as seen from the side of the uncoated sheet was characterized in reflection (specular reflection excluded) using a spectrocolorimeter, and the results are presented in the table below.

TABLE 1

| Zone | L* | a* | b* |
|---|---|---|---|
| Enamel only | 3.7 | 0.1 | 0.4 |
| Z₁ | 4.0 | 0.1 | −0.6 |
| Z₂ | 6.4 | −0.3 | −1.1 |
| Z₃ | 9.1 | −0.6 | −1.7 |

The results show that, in the case of a black enamel, the zones comprising the silica coating show a greyer shade in reflection, the thicker the coating the greyer the shade. The contrast between the different zones is sufficient to make the decorations perfectly visible.

1. A material comprising a glass sheet one side of which comprises an enameled zone, such that in said enameled zone the glass sheet is coated with an opaque mineral layer and, under at least part of said opaque mineral layer, with a transparent mineral coating which is not an enamel, said transparent mineral coating comprising, in said enameled zone, a first zone wherein the transparent mineral coating has a first thickness and a second zone wherein the transparent mineral coating has a second thickness, said first and second thicknesses being different.

2. The material according to claim 1, wherein the opaque mineral layer is an enamel or a silicate paint.

3. The material according to claim 1, wherein the opaque mineral layer is in contact with the transparent mineral coating.

4. The material according to claim 1, wherein the transparent mineral coating is such that, deposited on a sheet of clear glass, a light transmittance of the sheet of clear glass coated with the transparent mineral coating is at least 70%.

5. The material according to claim 1_, wherein the transparent mineral coating is colorless.

6. The material according to claim 1, wherein the transparent mineral coating comprises, at least in the first or second zone, a plurality of superimposed layers.

7. The material according to claim 1, wherein the transparent mineral coating comprises N zones Zₓ, N being at least 2 and x ranging from 1 to N, the thickness eₓ of the transparent mineral coating in zone Zₓ being different from the thickness e_{y} of the transparent mineral coating in zone Z_{y}, for any x different from y.

8. The material according to claim 1, wherein the thickness of the transparent mineral coating in each zone is between 30 and 1000 nm.

9. The material according to claim 1, wherein a ratio between the second thickness and the first thickness(es) is at least 1.2.

10. The material according to claim 1, wherein the transparent mineral coating is based on an oxide of one or more elements chosen from Si, Zr, Ti, Zn, Sn and Al.

11. The material according to claim 1, wherein the transparent mineral coating is a sol-gel coating.

12. A method for obtaining a material according to claim 1, comprising depositing, on one face of a glass sheet and in an enameled zone, of a transparent mineral coating which is not an enamel, then, on this transparent mineral coating, an opaque mineral layer, said transparent mineral coating comprising, in said enameled zone, a first zone wherein the transparent mineral coating has a first thickness and a second zone wherein the transparent mineral coating has a second thickness, said first and second thicknesses being different.

13. The method according to claim 12, wherein the transparent mineral coating is deposited by a sol-gel method, and the opaque mineral layer is deposited by screen printing or digital printing.

14. The method according to claim 13, wherein the transparent mineral coating is deposited by screen or inkjet printing.

15. A glazing comprising at least one material according to claim 1.

16. The material according to claim 4, wherein light transmittance of the sheet of clear glass coated with the transparent mineral coating is at least 80%.

17. The material according to claim 8, wherein the thickness of the transparent mineral coating in each zone is between 50 and 500 nm.

18. The material according to claim 9, wherein the ratio between the second thickness and the first thickness is at least 1.5.

19. The material according to claim 10, wherein the transparent mineral coating is based on silicon oxide.
